(19) United States
(12) Patent Application Publication
(10) Pub. No.: US 2006/0171302 A1
(43) Pub. Date: Aug. 3, 2006

(54) Data transmission in a network comprising bridges

(75) Inventor: Francois Edouard Tallet, Santa Clara, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/050,540

(22) Filed: Feb. 3, 2005

(51) Int. Cl. H04L 12/28

(52) U.S. Cl. 370/225

(57) ABSTRACT

A method, system, apparatus, and machine-readable medium for data transmission in a segment of a network through a bridge are provided. The bridge comprises one designated forwarding port and at least one backup port. The method selects a best backup port from amongst the available backup ports. On detection of a failure of data transmission through the designated forwarding port, the data is transmitted through the best backup port without any time delay. When a failed designated forwarding port recovers from the failure of data transmission, the data is transmitted through the recovered failed forwarding port without any time delay. The system includes a selector, a detector, and a switching module to implement the above method.

### BACKGROUND OF THE INVENTION

1. Field of Invention

This invention relates in general to data transmission in a network. More specifically, the invention relates to methods and systems for data transmission in a segment of a network through a bridge.

2. Description of the Background Art

A network with at least one bridge is referred to as a bridged network. A bridge divides the network into one or more network segments. Data between network segments is exchanged through the bridge. The bridge includes a plurality of ports, used for data transmission across the bridge. In a bridged network, there can be multiple paths for data transmission between two network segments, which may lead to an infinite loop situation known as bridge loops. Bridges use spanning tree protocol (STP) to avoid bridge loops. STP sends Bridge Protocol Data Units (BPDUs) on different ports of a bridge, to determine the most efficient path. On a given segment, a comparison of the BPDUs sent on different ports is performed, and the port with the best BPDU is elected as designated port. After a convergence phase, data across the bridge is eventually transmitted through the designated port, when its state becomes forwarding. A designated port connected to such a shared segment usually needs a 2×forward_delay to reach this forwarding state. All other ports from the same bridge connected to this segment are elected as backup ports. Backup ports have a discarding state and are not used to forward data. Backup ports may change their role to designated port in the event of a failure of data transmission through the designated port.

A designated port stops sending BPDUs on the segment if there is a failure of data transmission. If a backup port does not receive BPDUs from the designated port within a predetermined time period (max_age), the backup port considers the designated port as failed and starts sending its BPDUs. The port, from amongst the backup ports, with the best BPDUs becomes the designated port. Again, an additional 2×forward_delay is necessary for this new designated port to become forwarding. Thus, the process of restoring transmission across the bridge, in the event of a failure, takes time equal to max_age+2×forward_delay. If the failed designated port becomes active again, it sends a BPDU on the segment and is immediately elected designated port. The backup port acting as the designated port is reverted to a backup port. This process needs time equal to 2×foward_delay (time necessary for the designated port to become forwarding) before transmission is re-established. The time involved here is very critical in situations where multiple computers use the same communication path at a given time.

### SUMMARY OF EMBODIMENTS OF THE INVENTION

In one embodiment, the invention provides a method for data transmission in a segment of a network through a bridge, the bridge comprising one designated forwarding port and at least one available backup port. The method comprises (i) selecting a backup port as a best backup port from amongst the available backup ports; and (ii) transmitting data through the best backup port when a failure of data transmission through the designated forwarding port is detected, the data being transmitted without any time delay.

In another embodiment, the invention provides a method for data transmission in a segment of a network through a bridge, the bridge comprising one designated forwarding port and at least one available backup port. The method comprises (i) selecting a backup port as a best backup port from amongst the available backup ports; (ii) transmitting data through the best backup port when a failure of data transmission through the designated forwarding port is detected, the data being transmitted without any time delay; and (iii) transmitting data through the failed designated forwarding port on recovery from the failure of data transmission, the data being transmitted without any time delay.

In another embodiment, the invention provides a system for data transmission in a segment of a network through a bridge, the bridge comprising one designated forwarding port and at least one available backup port. The system comprises (i) means for selecting a backup port as a best backup port from amongst the available backup ports; (ii) means for transmitting data through the best backup port when a failure of data transmission through the designated forwarding port is detected, the data being transmitted without any time delay; and (iii) means for changing status of the ports.

In another embodiment, the invention provides a system for data transmission in a segment of a network through a bridge, the bridge comprising one designated forwarding port and at least one available backup port. The system comprises (i) a selector for selecting a best backup port from amongst the available backup ports; (ii) a detector for detecting a failure or a recovery of data transmission through the designated forwarding port; and (iii) a switching module for changing status of the ports.

In another embodiment, the invention provides an apparatus for data transmission in a segment of a network through a bridge, the bridge comprising one designated forwarding port and at least one available backup port. The apparatus comprises (i) a processor; and (ii) a machine-readable medium including instructions executable by a processor. The machine-readable medium comprises (a) one or more instructions for selecting a backup port as a best backup port from amongst the available backup ports; (b) one or more instructions for transmitting data through the best backup port when a failure of data transmission through the designated forwarding port is detected, the data being transmitted without any time delay; and (c) one or more instructions for transmitting the data through the failed designated forwarding port on recovery from the failure of data transmission, the data being transmitted without any time delay.

In further embodiments of the present invention, a machine-readable medium is provided for data transmission in a segment of a network through a bridge, the bridge comprising one designated forwarding port and at least one available backup port. The machine-readable medium comprises (i) one or more instructions for selecting a backup port as a best backup port from amongst the available backup ports; (ii) one or more instructions for transmitting data through the best backup port when a failure of data transmission through the designated forwarding port is detected, the data being transmitted without any time delay; and (iii) one or more instructions for transmitting the data through the failed designated forwarding port on recovery from the failure of data transmission, the data being transmitted without any time delay.

These provisions, together with the various ancillary provisions and features that will become apparent to those artisans who possess skill in the art, as the following description proceeds, are attained by devices, assemblies, systems, and methods of embodiments of the present invention, various embodiments thereof being shown with reference to the accompanying drawings, by way of example only, wherein:

### BRIEF DESCRIPTION OF THE DRAWINGS

FIG. 1 depicts a network, wherein an exemplary embodiment of the present invention can be practiced.

FIG. 2 is a block diagram of a data transmission system, in accordance with an exemplary embodiment of the present invention.

FIG. 3 is a flowchart of a method for data transmission in a segment of a network through a bridge, in accordance with an exemplary embodiment of the present invention.

### DETAILED DESCRIPTION OF EMBODIMENTS OF THE INVENTION

The invention provides a method, a system, an apparatus, and a machine-readable medium for data transmission in a segment of a network through a bridge. The invention instantly detects and restores a failure of data transmission through a bridge. The invention avoids the max_age and forward_delay time associated with the conventional methods and systems for the restoration of data transmission.

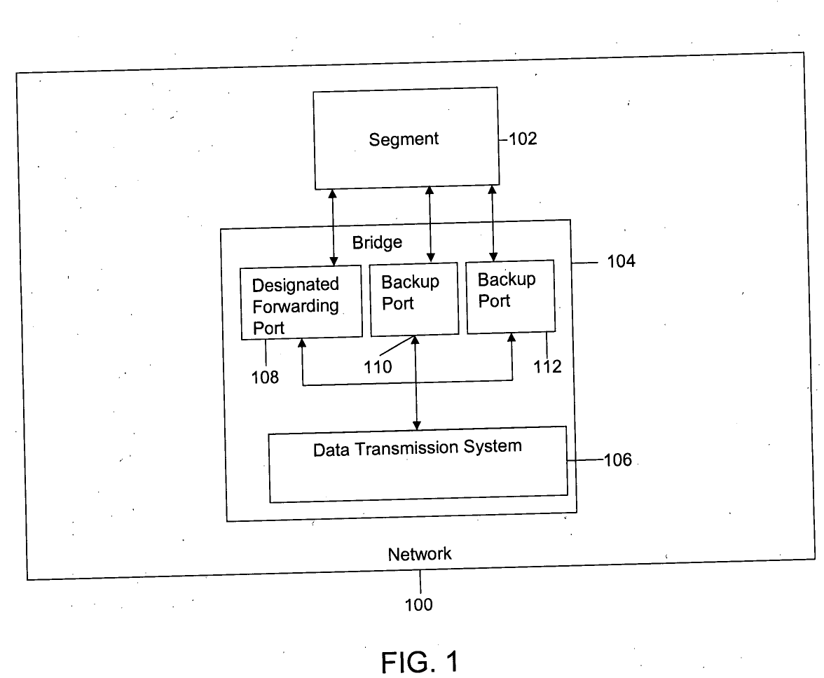

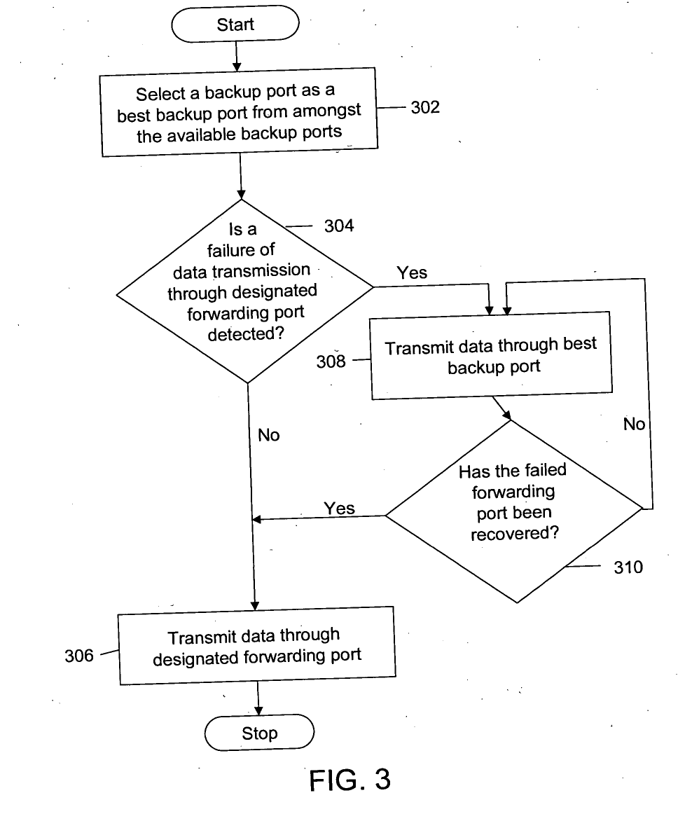

FIG. 1 depicts a network 100, in accordance with an exemplary embodiment of the present invention. Network 100 includes a segment 102, a bridge 104, and a data transmission system 106. Examples of segment 102 include a network of computers connected to form a Local Area Network (LAN), a network of computers connected to form a metro Ethernet, and the like. Data in segment 102 is transmitted through bridge 104. Data through bridge 104 is transmitted in the form of data packets. Each data packet carries information and has a destination address. For example, in a computer network, the destination address of a data packet is the location of a computer within the computer network to which the data packet is to be delivered. Bridge 104 includes a designated forwarding port 108, at least one backup port, for example, a backup port 110 and a backup port 112. Data through bridge 104 is transmitted through designated forwarding port 108. Data is transmitted through one of the backup ports of bridge 104 when there is a failure of data transmission through designated forwarding port 108. Data transmission through a best back port is further explained in conjunction with FIG. 3. Data transmission system 106 monitors data transmission through bridge 104. In an exemplary embodiment of the present invention, data transmission system 106 can be implemented as a part of bridge 104. Data transmission system 106 can be implemented as hardware, software, and their combination thereof.

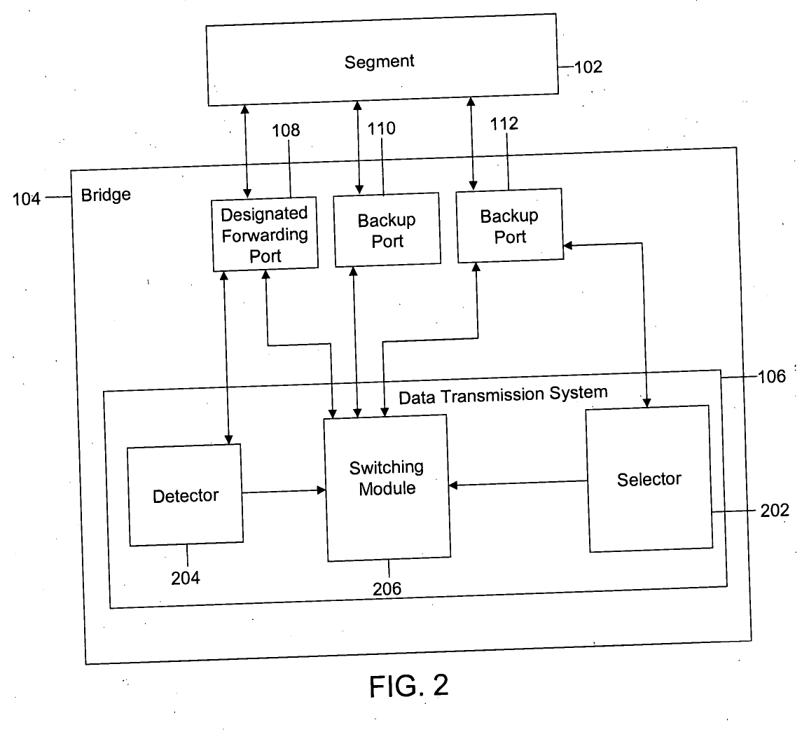

FIG. 2 is a block diagram of data transmission system 106, in accordance with an exemplary embodiment of the present invention. Data transmission system 106 includes a selector 202, a detector 204, and a switching module 206. Selector 202 selects a backup port as a best backup port from amongst the available backup ports of bridge 104. Selection of the best backup port is further explained in conjunction with FIG. 3. In an exemplary embodiment of the present invention, selector 202 can be implemented in the form of software, hardware, and their combination thereof.

Detector 204 performs a check to detect a failure of data transmission through designated forwarding port 108. Further, detector 204 provides information about the failure of data transmission to switching module 206. Further, in one embodiment of the present invention, detector 204 performs a check to detect a recovery of designated forwarding port 108 from the failure of data transmission. Information about recovery of designated forwarding port 108 is provided to switching module 206 by detector 204. In an embodiment, detector 204 checks the link status of a port to identify the failure of data transmission through the port. In an exemplary embodiment of the present invention, detector 204 can be implemented in the form of software, hardware, and their combination thereof. Switching module 206, based on the information provided by detector 204 changes the status of designated forwarding port 108 and the best backup port. In an exemplary embodiment of the invention, switching module 206 can be implemented in the form of software, hardware, and their combination thereof.

FIG. 3 is a flowchart of a method for data transmission in a segment 102 of a network 100 through a bridge 104, in accordance with an exemplary embodiment of the present invention. At step 302, selector 202 selects a best backup port from amongst the available backup ports of bridge 104. In an embodiment of the invention, the best backup port is selected by using standard Spanning Tree Protocol Algorithm (STP). For example, backup port 110 is selected as the best backup port, hereinafter referred to as best backup port 110.

In an embodiment of the invention, identification of the ports that have a backup role is possible because a port has a backup role only as a result of receiving BPDUs from a designated port located on the same physical bridge. In an embodiment of the invention, the best backup port from amongst the available backup ports is identified by using the standard IEEE 802.1D procedure.

At step 304, a check is performed by detector 204 to detect a failure of data transmission through designated forwarding port 108. The failure of data transmission is detected by checking the link status of designated forwarding port 108. If the failure of designated forwarding port 108 is not detected, at step 306, the data is transmitted through designated forwarding port 108. If a failure of data transmission through designated forwarding port 108 is detected, data is transmitted through best back up port 110 without any time delay at step 308.

At step 308, detector 204 provides information about the failure to switching module 206. Designated forwarding port 108, on the failure of data transmission through it, is referred to as failed designated forwarding port 108. Switching module 206, based on the information provided by detector 204 changes the status of designated forwarding port 108 and best backup port 110. The status is changed without any time delay. Switching module 206 changes the status of best backup port 110 from the backup state to the designated forwarding state, i.e., best backup port 110 is not only elected as the designated port, but it is put into the forwarding state. In addition, the status of failed designated forwarding port 108 is changed from the designated forwarding state to the disabled state. When a port fails to transmit data, the state of the port is disabled. Once the status of best backup port 110 is changed to the designated forwarding, data is transmitted through best backup port 110 without any time delay. An STP topology change notification is also generated and transmitted through best backup port 110.

In an embodiment of the present invention, at step 310, a check is performed by detector 204 to detect the recovery of failed designated forwarding port 108 from the failure of the data transmission. If failed designated forwarding port 108 starts sending Bridge Protocol Data Units (BPDUs) on segment 102 that are superior to BPDUs of best backup port 110, failed forwarding port 108 is then considered as recovered. Once the recovery of failed designated forwarding port 108 is detected, the information about the recovery is provided to switching module 206. Switching module 206 changes the status of failed designated forwarding port 108 from the disabled state to the designated forwarding state without any time delay. Further, switching module 206 changes the status of best backup port 110 from the designated forwarding state to the backup state without any time delay. Once the status of failed designated forwarding port 108 is changed to designated forwarding, at step 306, the data is transmitted through designated forwarding port 108. A topology change notification is again generated as a result of failed designated forwarding port 108 moving to the designated forwarding state. If the recovery of failed designated forwarding port 108 is not detected, step 308 is repeated.

Embodiments of the present invention have the advantage that a failure of data transmission through bridge 104 is detected without any time delay. This avoids the max_age time. Further, the change in the status of designated forwarding port 108 and best backup port 110 is achieved without any time delay. Further, after the change in status, the data through bridge 104 is transmitted without any time delay. The above mentioned advantages lead to reduction in the time required for restoration of data transmission in the event of a failure of data transmission. In case of the failure of designated forwarding port 108, the time required for restoration of data is zero seconds, against 2×forward_delay+max_age, according to conventional methods. In case of the recovery of failed designated forwarding port 108, the time required for restoration of data transmission is zero seconds, against 2×forward_delay, according to conventional methods.

Although the invention has been discussed with respect to specific embodiments thereof, these embodiments are merely illustrative, and not restrictive, of the invention. For example, a ‘method for data transmission in a segment of a network through a bridge’ can include any type of analysis, manual or automatic, to anticipate the needs of the method.

Although specific protocols have been used to describe embodiments, other embodiments can use other transmission protocols or standards. Use of the terms ‘peer’, ‘client’, and ‘server’ can include any type of device, operation, or other process. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer were employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures,, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims

What is claimed is:

1. A method for data transmission in a segment of a network through a bridge, the bridge comprising one designated forwarding port and at least one available backup port, the method comprising
selecting a backup port as a best backup port from amongst the available backup ports; and
transmitting data through the best backup port when a failure of data transmission through the designated forwarding port is detected, the data being transmitted without any time delay.

2. The method of claim 1 further comprising transmitting the data through the failed designated forwarding port on recovery from the failure of data transmission, the data being transmitted without any time delay.

3. The method of claim 1 wherein the best backup port is selected by using Spanning Tree Protocol (STP) algorithm.

4. A method for data transmission in a segment of a network through a bridge, the bridge comprising one designated forwarding port and at least one available backup port, the method comprising
selecting a backup port as a best backup port from amongst the available backup ports;
transmitting data through the best backup port when a failure of data transmission through the designated forwarding port is detected, the data being transmitted without any time delay; and
transmitting the data through the failed designated forwarding port on recovery from the failure of data transmission, the data being transmitted without any time delay.

5. The method of claim 4 wherein the best backup port is selected by using STP algorithm.

6. A system for data transmission in a segment of a network through a bridge, the bridge comprising one designated forwarding port and at least one available backup port, the system comprising
means for selecting a backup port as a best backup port from amongst the available backup ports;
means for detecting a failure of data transmission through the designated forwarding port; and
means for changing status of the ports.

7. The system of claim 6 wherein the best backup port is selected by using STP.

8. A system for data transmission in a segment of a network through a bridge, the bridge comprising one designated forwarding port and at least one available backup port, the system comprising
a selector for selecting a best backup port from amongst the available backup ports;
a detector for detecting a failure or a recovery of data transmission through the designated forwarding port; and
a switching module for changing status of the ports.

9. The system of claim 8 wherein the best backup port is selected by using STP algorithm.

10. An apparatus for data transmission in a segment of a network through a bridge, the bridge comprising one designated forwarding port and at least one available backup port, the apparatus comprising
a processor; and
a machine-readable medium including instructions executable by a processor comprising
one or more instructions for selecting a backup port as a best backup port from amongst the available backup ports;
one or more instructions for transmitting data through the best backup port when a failure of data transmission through the designated forwarding port is detected, the data being transmitted without any time delay; and
one or more instructions for transmitting the data through the failed designated forwarding port on recovery from the failure of data transmission, the data being transmitted without any time delay.

11. A machine-readable medium including instructions executable by a processor for data transmission in a segment of a network through a bridge, the bridge comprising one designated forwarding port and at least one available backup port, the machine-readable medium comprising
one or more instructions for selecting a backup port as a best backup port from amongst the available backup ports;
one or more instructions for transmitting data through the best backup port when a failure of data transmission through the designated forwarding port is detected, the data being transmitted without any time delay; and
one or more instructions for transmitting the data through the failed designated forwarding port on recovery from the failure of data transmission, the data being transmitted without any time delay.
